(19) United States
(12) Patent Application Publication
(10) Pub. No.: US 2024/0061644 A1
(43) Pub. Date: Feb. 22, 2024

(54) METHOD AND SYSTEM FOR FACILITATING WORKFLOWS VIA VOICE COMMUNICATION

(71) Applicant: JPMorgan Chase Bank, N.A., New York, NY (US)

(72) Inventors: Dinesh Babu PARTHASARATHI, Bournemouth (GB); Srivathsan RAJAN, Bengaluru (IN)

(73) Assignee: JPMorgan Chase Bank, N.A., New York, NY (US)

(21) Appl. No.: 17/956,515

(22) Filed: Sep. 29, 2022

(30) Foreign Application Priority Data
Aug. 17, 2022 (IN) 202211046708

(51) Int. Cl. G06F 3/16; G06F 21/32; G10L 15/08; G10L 17/22

(52) U.S. Cl. CPC G06F 3/167; G06F 21/32; G10L 15/08; G10L 17/22; G10L 2015/088

(57) ABSTRACT

A method for facilitating workflows via an all-in-one voice feature is disclosed. The method includes receiving, via a user device, a request from a user, the request relating to an activation request for a workflow; authenticating the user via multi-factor authentication; providing, via the user device, audible prompts that relate to the workflow to obtain a response from the user, the response including a natural language response; parsing, by using a model, the obtained response to identify information necessary for execution of the workflow; determining, by using the model, whether additional data is required for the workflow based on the identified information; and automatically initiating, in real-time based on a result of the determining, the workflow using the identified information.

### CROSS-REFERENCE TO RELATED APPLICATIONS

This application claims the benefit of Indian Patent Application No. 202211046708, filed Aug. 17, 2022, which is hereby incorporated by reference in its entirety.

### BACKGROUND

### 1. Field of the Disclosure

This technology generally relates to methods and systems for executing workflows, and more particularly to methods and systems for facilitating automated workflows through natural language voice commands via an all-in-one voice feature.

### 2. Background Information

Many business entities provide electronic services such as, for example, trading of equity instruments via applications on user devices. Often, the electronic services are facilitated by various workflows that require interaction with a user. Historically, implementations of conventional user interaction techniques have resulted in varying degrees of success with respect to effectively and efficiently gathering necessary information from the user for the workflows.

One drawback of using the conventional user interaction techniques is that in many instances, large quantities of the necessary information must be obtained from the user as keyed-in data in response to requests presented on the user device. As a result, performance of the workflows is limited by the data entry speed and data entry accuracy of the user. For example, a price of an equity instrument may change prior to initiation of a purchasing workflow due to the length of time required for the user to key in the large quantity of necessary information. Additionally, for users with challenges such as, for example, hand and nerve challenges, performance of the workflows may be further limited due to decreased data entry speed.

Therefore, there is a need to facilitate automated workflows through natural language voice commands via an all-in-one voice feature that eliminates the need for any keyed-in manual intervention by the user.

### SUMMARY

The present disclosure, through one or more of its various aspects, embodiments, and/or specific features or sub-components, provides, inter alia, various systems, servers, devices, methods, media, programs, and platforms for facilitating automated workflows through natural language voice commands via an all-in-one voice feature.

According to an aspect of the present disclosure, a method for facilitating workflows via an all-in-one voice feature is disclosed. The method is implemented by at least one processor. The method may include receiving, via a user device, a request from a user, the request may relate to an activation request for at least one workflow; authenticating the user via multi-factor authentication; providing, via the user device, at least one audible prompt that relates to the at least one workflow to obtain a response from the user, the response may include a natural language response; parsing, by using at least one model, the obtained response to identify information necessary for execution of the at least one workflow; determining, by using the at least one model, whether additional data is required for the at least one workflow based on the identified information; and automatically initiating, in real-time based on a result of the determining, the at least one workflow using the identified information.

In accordance with an exemplary embodiment, the method may further include providing, via the user device, at least one secondary audible prompt that relates to the at least one workflow to obtain the additional data when the additional data is determined to be required; and automatically initiating, in real-time, the at least one workflow based on the identified information and the obtained additional data.

In accordance with an exemplary embodiment, to receive the request from the user, the method may further include detecting, via the user device, at least one wake word, the at least one wake word may correspond to at least one from among a word and a phrase that initiates voice recognition; recording, via the user device, the request based on a result of the detecting, the request may correspond to a verbal request that includes at least one command and workflow data; and identifying the at least one workflow using the recording of the request.

In accordance with an exemplary embodiment, the at least one workflow may include a banking operation that relates to at least one from among a trade operation, a payment operation, an account services operation, a loan operation, and a deposit operation.

In accordance with an exemplary embodiment, the multi-factor authentication may include at least one from among voice recognition, face recognition, and fingerprint validation, the voice recognition may relate to identification of the user based on at least one voice characteristic of the user.

In accordance with an exemplary embodiment, the at least one voice characteristic may be identified from user vocalizations in the request.

In accordance with an exemplary embodiment, to provide the at least one audible prompt, the method may further include identifying at least one process flow that is associated with each of the at least one workflow based on the request; determining a sequence of at least one inquiry that corresponds to the at least one process flow; and providing, via the user device, the at least one audible prompt based on the determined sequence of the at least one inquiry.

In accordance with an exemplary embodiment, to determine whether the additional data is required, the method may further include identifying a profile that corresponds to the user, the profile may include user information and a historical record of a plurality of workflows initiated by the user; extracting workflow data that corresponds to the at least one workflow from the profile; and determining whether the additional data is required for the at least one workflow based on the identified information and the extracted workflow data.

In accordance with an exemplary embodiment, the at least one model may include at least one from among a natural language processing model, a machine learning model, a mathematical model, a process model, and a data model.

According to an aspect of the present disclosure, a computing device configured to implement an execution of a method for facilitating workflows via an all-in-one voice feature is disclosed. The computing device including a processor; a memory; and a communication interface coupled to each of the processor and the memory, wherein the processor may be configured to receive, via a user device, a request from a user, the request may relate to an activation request for at least one workflow; authenticate the user via multi-factor authentication; provide, via the user device, at least one audible prompt that relates to the at least one workflow to obtain a response from the user, the response may include a natural language response; parse, by using at least one model, the obtained response to identify information necessary for execution of the at least one workflow; determine, by using the at least one model, whether additional data is required for the at least one workflow based on the identified information; and automatically initiate, in real-time based on a result of the determining, the at least one workflow using the identified information.

In accordance with an exemplary embodiment, the processor may be further configured to provide, via the user device, at least one secondary audible prompt that relates to the at least one workflow to obtain the additional data when the additional data is determined to be required; and automatically initiate, in real-time, the at least one workflow based on the identified information and the obtained additional data.

In accordance with an exemplary embodiment, to receive the request from the user, the processor may be further configured to detect, via the user device, at least one wake word, the at least one wake word may correspond to at least one from among a word and a phrase that initiates voice recognition; record, via the user device, the request based on a result of the detecting, the request may correspond to a verbal request that includes at least one command and workflow data; and identify the at least one workflow using the recording of the request.

In accordance with an exemplary embodiment, the at least one workflow may include a banking operation that relates to at least one from among a trade operation, a payment operation, an account services operation, a loan operation, and a deposit operation.

In accordance with an exemplary embodiment, the multi-factor authentication includes at least one from among voice recognition, face recognition, and fingerprint validation, the voice recognition may relate to identification of the user based on at least one voice characteristic of the user.

In accordance with an exemplary embodiment, the processor may be further configured to identify the at least one voice characteristic from user vocalizations in the request.

In accordance with an exemplary embodiment, to provide the at least one audible prompt, the processor may be further configured to identify at least one process flow that is associated with each of the at least one workflow based on the request; determine a sequence of at least one inquiry that corresponds to the at least one process flow; and provide, via the user device, the at least one audible prompt based on the determined sequence of the at least one inquiry.

In accordance with an exemplary embodiment, to determine whether the additional data is required, the processor may be further configured to identify a profile that corresponds to the user, the profile may include user information and a historical record of a plurality of workflows initiated by the user; extract workflow data that corresponds to the at least one workflow from the profile; and determine whether the additional data is required for the at least one workflow based on the identified information and the extracted workflow data.

In accordance with an exemplary embodiment, the at least one model may include at least one from among a natural language processing model, a machine learning model, a mathematical model, a process model, and a data model.

According to an aspect of the present disclosure, a non-transitory computer readable storage medium storing instructions for facilitating workflows via an all-in-one voice feature is disclosed. The storage medium including executable code which, when executed by a processor, may cause the processor to receive, via a user device, a request from a user, the request may relate to an activation request for at least one workflow; authenticate the user via multi-factor authentication; provide, via the user device, at least one audible prompt that relates to the at least one workflow to obtain a response from the user, the response may include a natural language response; parse, by using at least one model, the obtained response to identify information necessary for execution of the at least one workflow; determine, by using the at least one model, whether additional data is required for the at least one workflow based on the identified information; and automatically initiate, in real-time based on a result of the determining, the at least one workflow using the identified information.

In accordance with an exemplary embodiment, the at least one workflow may include a banking operation that relates to at least one from among a trade operation, a payment operation, an account services operation, a loan operation, and a deposit operation.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for facilitating automated workflows through natural language voice commands via an all-in-one voice feature.

FIG. 4 is a flowchart of an exemplary process for implementing a method for facilitating automated workflows through natural language voice commands via an all-in-one voice feature.

FIG. 5 is a flow diagram of an exemplary process for implementing a method for facilitating automated workflows through natural language voice commands via an all-in-one voice feature.

### DETAILED DESCRIPTION

Through one or more of its various aspects, embodiments and/or specific features or sub-components of the present disclosure are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

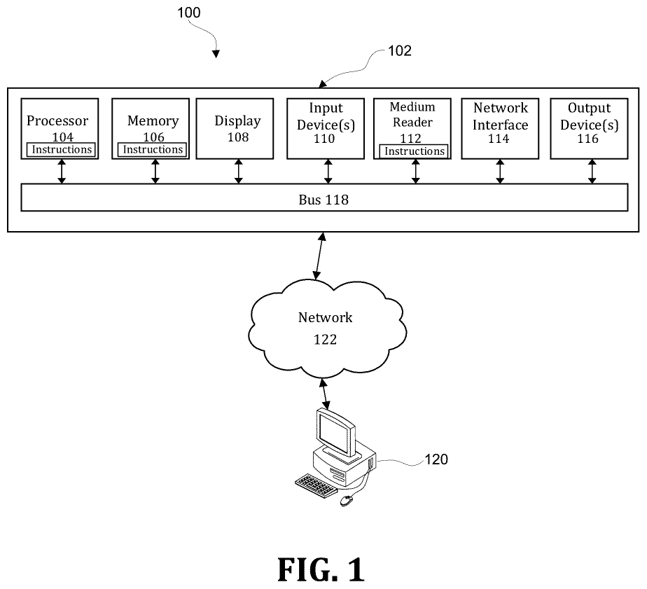

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a virtual desktop computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disc read only memory (CD-ROM), digital versatile disc (DVD), floppy disk, blu-ray disc, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other type of display, examples of which are well known to persons skilled in the art.

The computer system 102 may also include at least one input device 110, such as a keyboard, a touch-sensitive input screen or pad, a speech input, a mouse, a remote-control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for facilitating automated workflows through natural language voice commands via an all-in-one voice feature.

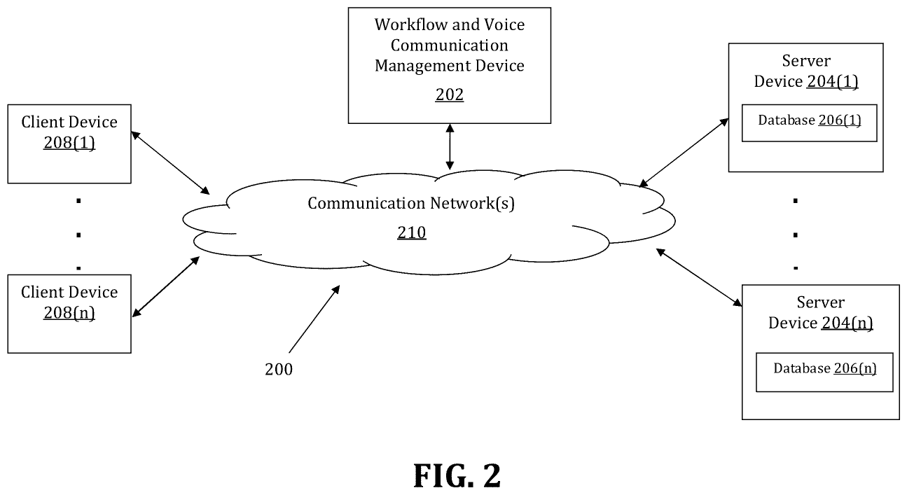

Referring to FIG. 2, a schematic of an exemplary network environment 200 for implementing a method for facilitating automated workflows through natural language voice commands via an all-in-one voice feature is illustrated. In an exemplary embodiment, the method is executable on any networked computer platform, such as, for example, a personal computer (PC).

The method for facilitating automated workflows through natural language voice commands via an all-in-one voice feature may be implemented by a Workflow and Voice Communication Management (WVCM) device 202. The WVCM device 202 may be the same or similar to the computer system 102 as described with respect to FIG. 1. The WVCM device 202 may store one or more applications that can include executable instructions that, when executed by the WVCM device 202, cause the WVCM device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the WVCM device 202 itself, may be located in virtual server(s) running in a cloud-based computing environment rather than being tied to one or more specific physical network computing devices. Also, the application(s) may be running in one or more virtual machines (VMs) executing on the WVCM device 202. Additionally, in one or more embodiments of this technology, virtual machine(s) running on the WVCM device 202 may be managed or supervised by a hypervisor.

In the network environment 200 of FIG. 2, the WVCM device 202 is coupled to a plurality of server devices 204(1)-204(n) that hosts a plurality of databases 206(1)-206(n), and also to a plurality of client devices 208(1)-208(n) via communication network(s) 210. A communication interface of the WVCM device 202, such as the network interface 114 of the computer system 102 of FIG. 1, operatively couples and communicates between the WVCM device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the WVCM device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and WVCM devices that efficiently implement a method for facilitating automated workflows through natural language voice commands via an all-in-one voice feature.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The WVCM device 202 may be a standalone device or integrated with one or more other devices or apparatuses, such as one or more of the server devices 204(1)-204(n), for example. In one particular example, the WVCM device 202 may include or be hosted by one of the server devices 204(1)-204(n), and other arrangements are also possible. Moreover, one or more of the devices of the WVCM device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the WVCM device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data that relates to user requests, activation requests, workflows, authentication factors, user profiles, audible prompts, natural language responses, necessary information, natural language processing models, and user recordings.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a controller/agent approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the WVCM device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the WVCM device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the WVCM device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the WVCM device 202, the server devices 204(1)-204(n), or the client devices 208(1)-208(n), for example, may be configured to operate as virtual instances on the same physical machine. In other words, one or more of the WVCM device 202, the server devices 204(1)-204(n), or the client devices 208(1)-208(n) may operate on the same physical device rather than as separate devices communicating through communication network(s) 210. Additionally, there may be more or fewer WVCM devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication, also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

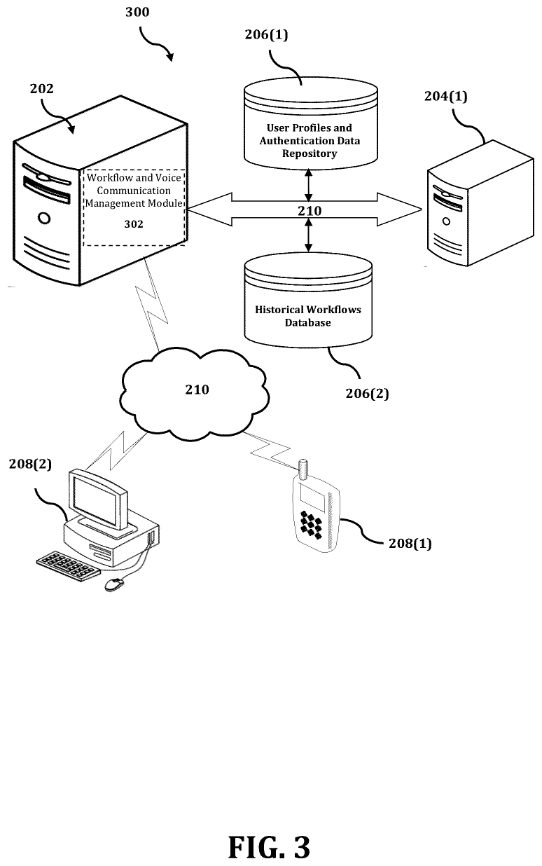

The WVCM device 202 is described and shown in FIG. 3 as including a workflow and voice communication management module 302, although it may include other rules, policies, modules, databases, or applications, for example. As will be described below, the workflow and voice communication management module 302 is configured to implement a method for facilitating automated workflows through natural language voice commands via an all-in-one voice feature.

An exemplary process 300 for implementing a mechanism for facilitating automated workflows through natural language voice commands via an all-in-one voice feature by utilizing the network environment of FIG. 2 is shown as being executed in FIG. 3. Specifically, a first client device 208(1) and a second client device 208(2) are illustrated as being in communication with WVCM device 202. In this regard, the first client device 208(1) and the second client device 208(2) may be “clients” of the WVCM device 202 and are described herein as such. Nevertheless, it is to be known and understood that the first client device 208(1) and/or the second client device 208(2) need not necessarily be “clients” of the WVCM device 202, or any entity described in association therewith herein. Any additional or alternative relationship may exist between either or both of the first client device 208(1) and the second client device 208(2) and the WVCM device 202, or no relationship may exist.

Further, WVCM device 202 is illustrated as being able to access a user profiles and authentication data repository 206(1) and a historical workflows database 206(2). The workflow and voice communication management module 302 may be configured to access these databases for implementing a method for facilitating automated workflows through natural language voice commands via an all-in-one voice feature.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the WVCM device 202 via broadband or cellular communication. Of course, these embodiments are merely exemplary and are not limiting or exhaustive.

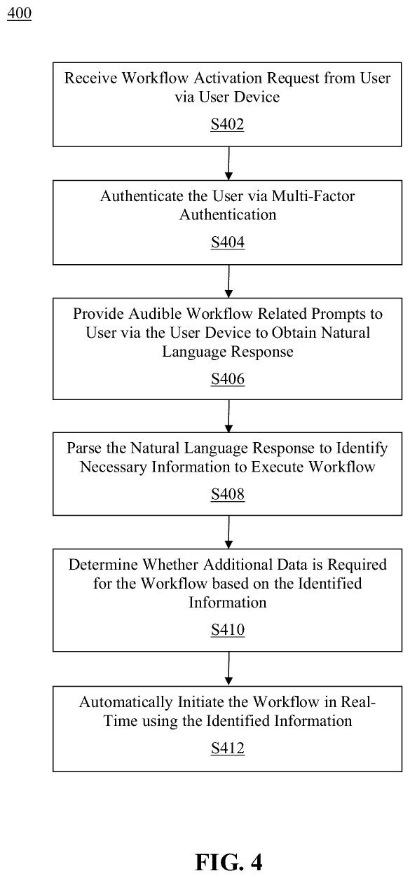

Upon being started, the workflow and voice communication management module 302 executes a process for facilitating automated workflows through natural language voice commands via an all-in-one voice feature. An exemplary process for facilitating automated workflows through natural language voice commands via an all-in-one voice feature is generally indicated at flowchart 400 in FIG. 4.

In the process 400 of FIG. 4, at step S402, a request may be received from a user. The request may be received from the user via a user device such as, for example, a mobile computing device and a personal computing device. The request may relate to an activation request for a workflow.

In an exemplary embodiment, the request may include at least one from among a verbal request and a non-verbal request to initiate the workflow. The verbal request may include a vocalization by the user in a natural language format. The non-verbal request may include interaction with the user device to provide an input that indicates a user desire to initiate the workflow. For example, the user may interact with a graphical element such as a button on a graphical user interface that is associated with a certain workflow. In another exemplary embodiment, consistent with present disclosures, the user may utilize both verbal and non-verbal requests together to initiate the workflow. For example, the user may physically interact with a graphical element to initiate voice recognition so that the user may provide verbal commands to initiate the workflow.

In another exemplary embodiment, the workflow may relate to a series of activities that are necessary to complete a task. In a linear workflow, an outside event may be utilized to initiate a first step. Each step in the linear workflow may include a specific step before and a specific step after, with the exception of the first and last steps. In a non-linear workflow, the workflow may split into multiple branches, each of which may be executed simultaneously and independently from each other.

In another exemplary embodiment, the workflow may include a banking operation that relates to at least one from among a trade operation, a payment operation, an account services operation, a loan operation, and a deposit operation. The trade operation may relate to initiating and executing a trade of financial instruments by specifying a buying/selling transaction type, a type of instrument, a name of the instrument, and a quantity of the instrument. The account services operation may include various account services such as, for example, balancing a checking account and viewing/extracting account statements. The payment operation may include various types of payments such as, for example, account to account transfers and outside transfers. The loan operation may relate to initiating a loan by selecting a type of loans with an amount, a rate of interest, and a loan tenure. The deposit operation may relate to initiating a deposit by giving deposit related details such as, for example, a current type, an amount, and a tenure.

In another exemplary embodiment, receiving the request from the user may include detecting a wake word via the user device. The wake word may correspond to at least one from among a word and a phrase that initiates a voice recognition function. Based on a result of the detecting, the request may be recorded via the user device. Consistent with present disclosures, the request may correspond to a verbal request that includes at least one from among commands and workflow data. Then, the user desired workflow may be identified by using the recording of the request.

In another exemplary embodiment, an application on the user device may be utilized to perform provided functions consistent with present disclosures. The application may correspond to a program and/or a piece of software that is designed and written to fulfill a particular purpose of the user. In another exemplary embodiment, the application may include at least one from among a monolithic application and a microservice application. The monolithic application may describe a single-tiered software application where the user interface and data access code are combined into a single program from a single platform. The monolithic application may be self-contained and independent from other computing applications.

In another exemplary embodiment, a microservice application may include a unique service and a unique process that communicates with other services and processes over a network to fulfill a goal. The microservice application may be independently deployable and organized around business capabilities. In another exemplary embodiment, the microservices may relate to a software development architecture such as, for example, an event-driven architecture made up of event producers and event consumers in a loosely coupled choreography. The event producer may detect or sense an event such as, for example, a significant occurrence or change in state for system hardware or software and represent the event as a message. The event message may then be transmitted to the event consumer via event channels for processing.

In another exemplary embodiment, the event-driven architecture may include a distributed data streaming platform such as, for example, an APACHE KAFKA platform for the publishing, subscribing, storing, and processing of event streams in real time. As will be appreciated by a person of ordinary skill in the art, each microservice in a microservice choreography may perform corresponding actions independently and may not require any external instructions.

In another exemplary embodiment, microservices may relate to a software development architecture such as, for example, a service-oriented architecture which arranges a complex application as a collection of coupled modular services. The modular services may include small, independently versioned, and scalable customer-focused services with specific business goals. The services may communicate with other services over standard protocols with well-defined interfaces. In another exemplary embodiment, the microservices may utilize technology-agnostic communication protocols such as, for example, a Hypertext Transfer Protocol (HTTP) to communicate over a network and may be implemented by using different programming languages, databases, hardware environments, and software environments.

At step S404, the user may be authenticated via multi-factor authentication. In an exemplary embodiment, the user may be authenticated to verify the user's identity. Verification of the user's identity may enable the user to access online services, connected devices, and other resources. In another exemplary embodiment, the user may be initially authenticated by the user device. For example, the user may be required to provide biometric information to the user device for authentication of the user's identity. In another exemplary embodiment, the user may be authenticated subsequent times after initial authentication by the user device. For example, the user may be authenticated by the user device, an application on the user device, as well as prior to initiating a workflow. As will be appreciated by a person of ordinary skill in the art, workflow security may be improved by additional user authentications.

In another exemplary embodiment, multi-factor authentication may relate to an authentication method that requires the user to provide two or more verification factors to gain access to a resource such as, for example, an application and an online account. The verification factors may correspond to pieces of evidence to an authentication mechanism such as, for example, a knowledge mechanism, a possession mechanism, and an inherence mechanism.

In another exemplary embodiment, the multi-factor authentication may include at least one from among voice recognition, face recognition, and fingerprint validation. The voice recognition may relate to identification of the user based on voice characteristics of the user. In another exemplary embodiment, the voice characteristics of the user may be identified from user vocalizations in the request. For example, the user may be automatically authenticated by using the recording of the request. Thus, by automatically authenticating the user using the recording of the request, workflow security may be improved without further inconvenience to the user. In another exemplary embodiment, the user may be authenticated based on user vocalizations at any step of the workflow. The voice characteristics may be extracted from any user vocalizations consistent with present disclosures.

At step S406, audible prompts that relate to the workflow may be provided to the user via the user device. The audible prompts may be provided to obtain a response from the user. The response may include a natural language response. In an exemplary embodiment, the audible prompts may include instructions for the user in a natural language format. The instructions may assist the user to provide necessary information for execution of the workflow. In another exemplary embodiment, subsequent audible prompts may be provided based on context of the user response. Consistent with present disclosures, the claimed invention may engage with the user in a natural language format to facilitate aggregation of workflow data in a conversational manner.

In another exemplary embodiment, to provide the audible prompts, process flows that are associated with the workflow may be identified based on the request. The process flow may provide information such as, for example, required workflow data that relates to steps associated with the workflow. Then, a sequence of inquiries that correspond to the process flow may be determined. For example, the sequence of inquiries may relate to a series of questions for the user to obtain the required workflow data for successful execution of the workflow. Finally, the audible prompts may be provided to the user via the user device based on the determined sequence of the inquires. That is, the audible prompts may directly correspond to the determined sequence of the inquiries.

At step S408, the obtained response from the user may be parsed by using a model. The obtained response may be parsed to identify information necessary for execution of the workflow. In an exemplary embodiment, the necessary information may correspond to information that is required by the workflow. For example, for a workflow associated with the trade of a financial instrument, information such as the type of financial instrument, the name of the financial instrument, and the quantity of the financial instrument is required to facilitate the desired trade.

In an exemplary embodiment, the vocalized response from the user may be parsed into a plurality of linguistic units that facilitate identification of the necessary information. The plurality of linguistic units may correspond to a natural unit in a language such as, for example, an English language into which linguistic messages can be analyzed. The plurality of linguistic units may relate to a linguistic expression that corresponds to at least one from among a paragraph and a sentence. In another exemplary embodiment, each of the plurality of linguistic units may correspond to a single word as well as to a string of words that express a complete thought. The string of words may together correspond to a linguistical unit that includes a subject and a predicate.

In another exemplary embodiment, the model may include at least one from among a natural language processing model, a machine learning model, a mathematical model, a process model, and a data model. The model may also include stochastic models such as, for example, a Markov model that is used to model randomly changing systems. In stochastic models, the future states of a system may be assumed to depend only on the current state of the system.

In another exemplary embodiment, machine learning and pattern recognition may include supervised learning algorithms such as, for example, k-medoids analysis, regression analysis, decision tree analysis, random forest analysis, k-nearest neighbors analysis, logistic regression analysis, etc. In another exemplary embodiment, machine learning analytical techniques may include unsupervised learning algorithms such as, for example, Apriori analysis, K-means clustering analysis, etc. In another exemplary embodiment, machine learning analytical techniques may include reinforcement learning algorithms such as, for example, Markov Decision Process analysis, etc.

In another exemplary embodiment, the model may be based on a machine learning algorithm. The machine learning algorithm may include at least one from among a process and a set of rules to be followed by a computer in calculations and other problem-solving operations such as, for example, a linear regression algorithm, a logistic regression algorithm, a decision tree algorithm, and/or a Naive Bayes algorithm.

In another exemplary embodiment, the model may include training models such as, for example, a machine learning model which is generated to be further trained on additional data. Once the training model has been sufficiently trained, the training model may be deployed onto various connected systems to be utilized. In another exemplary embodiment, the training model may be sufficiently trained when model assessment methods such as, for example, a holdout method, a K-fold-cross-validation method, and a bootstrap method determine that at least one of the training model's least squares error rate, true positive rate, true negative rate, false positive rate, and false negative rates are within predetermined ranges.

In another exemplary embodiment, the training model may be operable, i.e., actively utilized by an organization, while continuing to be trained using new data. In another exemplary embodiment, the models may be generated using at least one from among an artificial neural network technique, a decision tree technique, a support vector machines technique, a Bayesian network technique, and a genetic algorithms technique.

In another exemplary embodiment, the natural language processing model may correspond to a plurality of natural language processing techniques. The natural language processing techniques may include at least one from among a sentiment analysis technique, a named entity recognition technique, a summarization technique, a topic modeling technique, a text classification technique, a keyword extraction technique, and a lemmatization and stemming technique. As will be appreciated by a person of ordinary skill in the art, natural language processing may relate to computer processing and analyzing of large quantities of natural language data.

At step S410, whether additional data is required for the workflow may be determined. The determination may be made by using the model based on the identified information. In an exemplary embodiment, the additional data may correspond to information necessary for the execution of the workflow that is obtainable from a source other than the user. By automatically obtaining the necessary information from a source other than the user, the amount of data gathered from the user may be reduced. For example, to execute a workflow to deposit money into a user account, user account information may be automatically retrieved from a profile associated with the user. As will be appreciated by a person of ordinary skill in the art, reducing the amount of data gathered from the user may improve workflow performance as well as decrease user effort.

In another exemplary embodiment, to determine whether the additional data is required, a profile that corresponds to the user may be identified. The profile may include user information and a historical record of a plurality of workflows that have been initiated by the user. Workflow data that corresponds to the workflow may be extracted from the profile. Then, whether the additional data is required for the workflow may be determined based on the identified information and the extracted workflow data. Consistent with present disclosures, the disclosed invention may aggregate a variety of data associated with the user from a variety of data repositories.

In another exemplary embodiment, secondary audible prompts that relate to the workflow may be provided to the user via the user device. The secondary audible prompts may be provided to obtain the additional data when the additional data is determined to be required. For example, when the disclosed invention is not able to automatically locate the additional data due to an error such as a corrupted data file, the secondary audible prompts may be provided to the user for the additional data. Then, the workflow may be automatically initiated based on the identified information and the obtained additional data. Consistent with present disclosures, the workflow may be automatically initiated in real-time in response to the user request.

At step S412, the workflow may be automatically initiated by using the identified information. The workflow may be automatically initiated in real-time based on a result of the determining. In an exemplary embodiment, an interface such as, for example, an application programming interface may be used to communicate with external computing environments to facilitate the workflow. Various aspects of the workflow such as, for example, initiating a transfer of financial instruments may require interactions with an external computing environment. For example, the workflow may require interaction with an external entity such as a broker to facilitate trades of the financial instruments.

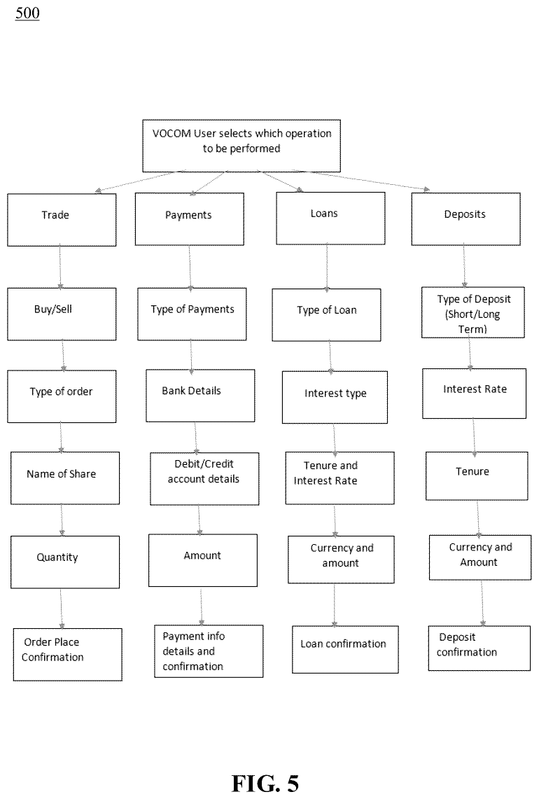

FIG. 5 is a flow diagram 500 of an exemplary process for implementing a method for facilitating automated workflows through natural language voice commands via an all-in-one voice feature. In FIG. 5, an exemplary sequence of inquires corresponding to various workflows is provided for presentation to the user consistent with present disclosures.

As illustrated in FIG. 5, the sequence of inquiries provided to the user may be based on the user request. The user may first select which operation to be performed, and then the user is presented with inquiries associated with the selected operation. For instance, when the user selects a trade operation, the disclosed invention will enable the user to verbally provide necessary information in a natural language format to facilitate a corresponding workflow. The user may interact with the disclosed invention in a conversational manner to provide buy/sell information, type of order information, and name of share information. The user may also initiate the workflow verbally and receive an order placed confirmation in response. Consistent with present disclosures, the user may select payment operations, loan operations, and deposit operations to facilitate corresponding workflows.

Accordingly, with this technology, an optimized process for facilitating automated workflows through natural language voice commands via an all-in-one voice feature is disclosed.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

1. A method for facilitating workflows via an all-in-one voice feature, the method being implemented by at least one processor, the method comprising:
receiving, by the at least one processor via a user device, a request from a user, the request relating to an activation request for at least one workflow,
wherein the at least one workflow includes a non-linear workflow that splits a series of activities into a plurality of branches; and
wherein the plurality of branches are simultaneously executed;
authenticating, by the at least one processor, the user via multi-factor authentication;
providing, by the at least one processor via the user device, at least one audible prompt that relates to the at least one workflow to obtain a response from the user, the response including a natural language response;
parsing, by the at least one processer using at least one model, the obtained response to identify information necessary for execution of the at least one workflow;
determining, by the at least one processor using the at least one model, whether additional data is required for the at least one workflow based on the identified information; and
automatically initiating, by the at least one processor in real-time based on a result of the determining, the at least one workflow using the identified information.

2. The method of claim 1, further comprising:
providing, by the at least one processor via the user device, at least one secondary audible prompt that relates to the at least one workflow to obtain the additional data when the additional data is determined to be required; and
automatically initiating, by the at least one processor in real-time, the at least one workflow based on the identified information and the obtained additional data.

3. The method of claim 1, wherein receiving the request from the user further comprises:
detecting, by the at least one processor via the user device, at least one wake word, the at least one wake word corresponding to at least one from among a word and a phrase that initiates voice recognition;
recording, by the at least one processor via the user device, the request based on a result of the detecting, the request corresponding to a verbal request that includes at least one command and workflow data; and
identifying, by the at least one processor, the at least one workflow using the recording of the request.

4. The method of claim 1, wherein the at least one workflow includes a banking operation that relates to at least one from among a trade operation, a payment operation, an account services operation, a loan operation, and a deposit operation.

5. The method of claim 1, wherein the multi-factor authentication includes at least one from among voice recognition, face recognition, and fingerprint validation, the voice recognition relating to identification of the user based on at least one voice characteristic of the user.

6. The method of claim 5, wherein the at least one voice characteristic is identified from user vocalizations in the request.

7. The method of claim 1, wherein providing the at least one audible prompt further comprises:
identifying, by the at least one processor, at least one process flow that is associated with each of the at least one workflow based on the request;
determining, by the at least one processor, a sequence of at least one inquiry that corresponds to the at least one process flow; and
providing, by the at least one processor via the user device, the at least one audible prompt based on the determined sequence of the at least one inquiry.

8. The method of claim 1, wherein determining whether the additional data is required further comprises:
identifying, by the at least one processor, a profile that corresponds to the user, the profile including user information and a historical record of a plurality of workflows initiated by the user;
extracting, by the at least one processor, workflow data that corresponds to the at least one workflow from the profile; and
determining, by the at least one processor, whether the additional data is required for the at least one workflow based on the identified information and the extracted workflow data.

9. The method of claim 1, wherein the at least one model includes at least one from among a natural language processing model, a machine learning model, a mathematical model, a process model, and a data model.

10. A computing device configured to implement an execution of a method for facilitating workflows via an all-in-one voice feature, the computing device comprising:
a processor;
a memory; and
a communication interface coupled to each of the processor and the memory,
wherein the processor is configured to:
receive, via a user device, a request from a user, the request relating to an activation request for at least one workflow,
wherein the at least one workflow includes a non-linear workflow that splits a series of activities into a plurality of branches; and
wherein the plurality of branches are simultaneously executed;
authenticate the user via multi-factor authentication;
provide, via the user device, at least one audible prompt that relates to the at least one workflow to obtain a response from the user, the response including a natural language response;
parse, by using at least one model, the obtained response to identify information necessary for execution of the at least one workflow;
determine, by using the at least one model, whether additional data is required for the at least one workflow based on the identified information; and
automatically initiate, in real-time based on a result of the determining, the at least one workflow using the identified information.

11. The computing device of claim 10, wherein the processor is further configured to:
provide, via the user device, at least one secondary audible prompt that relates to the at least one workflow to obtain the additional data when the additional data is determined to be required; and
automatically initiate, in real-time, the at least one workflow based on the identified information and the obtained additional data.

12. The computing device of claim 10, wherein, to receive the request from the user, the processor is further configured to:
detect, via the user device, at least one wake word, the at least one wake word corresponding to at least one from among a word and a phrase that initiates voice recognition;
record, via the user device, the request based on a result of the detecting, the request corresponding to a verbal request that includes at least one command and workflow data; and
identify the at least one workflow using the recording of the request.

13. The computing device of claim 10, wherein the at least one workflow includes a banking operation that relates to at least one from among a trade operation, a payment operation, an account services operation, a loan operation, and a deposit operation.

14. The computing device of claim 10, wherein the multi-factor authentication includes at least one from among voice recognition, face recognition, and fingerprint validation, the voice recognition relating to identification of the user based on at least one voice characteristic of the user.

15. The computing device of claim 14, wherein the processor is further configured to identify the at least one voice characteristic from user vocalizations in the request.

16. The computing device of claim 10, wherein, to provide the at least one audible prompt, the processor is further configured to:
identify at least one process flow that is associated with each of the at least one workflow based on the request;
determine a sequence of at least one inquiry that corresponds to the at least one process flow; and
provide, via the user device, the at least one audible prompt based on the determined sequence of the at least one inquiry.

17. The computing device of claim 10, wherein, to determine whether the additional data is required, the processor is further configured to:
identify a profile that corresponds to the user, the profile including user information and a historical record of a plurality of workflows initiated by the user;
extract workflow data that corresponds to the at least one workflow from the profile; and
determine whether the additional data is required for the at least one workflow based on the identified information and the extracted workflow data.

18. The computing device of claim 10, wherein the at least one model includes at least one from among a natural language processing model, a machine learning model, a mathematical model, a process model, and a data model.

19. A non-transitory computer readable storage medium storing instructions for facilitating workflows via an all-in-one voice feature, the storage medium comprising executable code which, when executed by a processor, causes the processor to:
receive, via a user device, a request from a user, the request relating to an activation request for at least one workflow,
wherein the at least one workflow includes a non-linear workflow that splits a series of activities into a plurality of branches; and
wherein the plurality of branches are simultaneously executed;
authenticate the user via multi-factor authentication;
provide, via the user device, at least one audible prompt that relates to the at least one workflow to obtain a response from the user, the response including a natural language response;
parse, by using at least one model, the obtained response to identify information necessary for execution of the at least one workflow;
determine, by using the at least one model, whether additional data is required for the at least one workflow based on the identified information; and
automatically initiate, in real-time based on a result of the determining, the at least one workflow using the identified information.

20. The storage medium of claim 19, wherein the at least one workflow includes a banking operation that relates to at least one from among a trade operation, a payment operation, an account services operation, a loan operation, and a deposit operation.
